(19) United States
(12) Patent Application Publication
(10) Pub. No.: US 2018/0043825 A1
(43) Pub. Date: Feb. 15, 2018

(54) AUTOMATIC DRIVING SYSTEM

(71) Applicant: TOYOTA JIDOSHA KABUSHIKI KAISHA, Toyota-shi (JP)

(72) Inventor: Kazuhiko NAKASHIMA, Miyoshi-shi (JP)

(73) Assignee: TOYOTA JIDOSHA KABUSHIKI KAISHA, Toyota-shi (JP)

(21) Appl. No.: 15/661,834

(22) Filed: Jul. 27, 2017

(30) Foreign Application Priority Data
Aug. 10, 2016 (JP) 2016-157675

(51) Int. Cl. B60Q 3/72; B60Q 3/80

(52) U.S. Cl. CPC B60Q 3/72; B60Q 3/80; B60Q 3/20

(57) ABSTRACT

An automatic driving system includes: an interior light configured to illuminate a vehicle compartment of a vehicle; an interior light control unit configured to control the interior light; and a driving control unit configured to perform automatic driving control of automatically driving the vehicle, end the automatic driving control when the automatic driving control is being performed, and switch driving of the vehicle from automatic driving to manual driving. The interior light control unit is configured to perform, when the interior light is lighted while the automatic driving control is being performed, dimming control of decreasing an illuminance of the interior light before the driving control unit switches the driving of the vehicle from the automatic driving to the manual driving.

### INCORPORATION BY REFERENCE

The disclosure of Japanese Patent Application No. 2016-157675 filed on Aug. 10, 2016 including the specification, drawings and abstract is incorporated herein by reference in its entirety.

### BACKGROUND

### 1. Technical Field

The disclosure relates to an automatic driving system.

### 2. Description of Related Art

As an automatic driving system, an automatic driving control device described in Japanese Patent Application Publication No. 2016-088334 (JP 2016-088334 A) is known. In the automatic driving control device described in JP 2016-088334 A, driving of a vehicle can be switched from automatic driving to manual driving.

### SUMMARY

In the above-mentioned technique, when an interior light is turned on while a vehicle is being driven by automatic driving in the night and driving of the vehicle is switched from automatic driving to manual driving, a driver has to see the darkness outside the vehicle in a state in which the driver's eyes are accustomed to a bright vehicle compartment. Accordingly, there is a likelihood that the driver will have difficulty in seeing the outside of the vehicle.

The disclosure provides an automatic driving system that can reduce a likelihood that a driver will have difficulty in seeing the outside of a vehicle when driving of a vehicle is switched from automatic driving to manual driving.

An aspect of the disclosure provides automatic driving system. The automatic driving system according to the aspect of the disclosure includes: an interior light configured to illuminate a vehicle compartment of a vehicle; an interior light control unit configured to control the interior light; and a driving control unit configured to perform automatic driving control of automatically driving the vehicle, end the automatic driving control when the automatic driving control is being performed, and switch driving of the vehicle from automatic driving to manual driving. The interior light control unit is configured to perform, when the interior light is lighted while the automatic driving control is being performed, dimming control of decreasing an illuminance of the interior light before the driving control unit switches the driving of the vehicle from the automatic driving to the manual driving.

According to this configuration, when the interior light is lighted while the vehicle is being driven by automatic driving, an illuminance of the interior light is decreased before driving of the vehicle is switched from automatic driving to manual driving. Accordingly, a driver's eyes can easily adapt to the darkness outside the vehicle. As a result, when driving of the vehicle is switched from automatic driving to manual driving, it is possible to reduce a likelihood that the driver will have difficulty in seeing the outside of the vehicle.

In the aspect of the disclosure, the automatic driving system may further includes a switching time setting unit configured to set, while the automatic driving control is being performed, a switching time at which the driving control unit switches the driving of the vehicle from the automatic driving to the manual driving. The interior light control unit may be configured to perform the dimming control, when both of a first condition and a second condition are satisfied. The first condition may be a condition that the interior light is lighted while the automatic driving control is being performed. The second condition may be a condition that a remaining time to the switching time is equal to or less than a first predetermined time.

According to this configuration, when the interior light is lighted while the vehicle is being driven by automatic driving, it is possible for the driver's eyes to easily adapt to the darkness outside the vehicle by decreasing an illuminance of the interior light a predetermined time prior to the set switching time.

In the aspect of the disclosure, the switching time setting unit may be configured to predict a timing, based on at least one of a surroundings condition of the vehicle, a traveling state of the vehicle, a position of the vehicle, and map data of the vehicle. The timing may be a time at which the vehicle enters a first area in which traveling by the automatic driving is not permitted or a second area in which traveling by the automatic driving is not possible. The switching time setting unit may be configured to set the timing as the switching time.

In the aspect of the disclosure, the interior light control unit may be configured to decrease the illuminance of the interior light by a predetermined proportion at predetermined intervals, when the remaining time to the switching time is equal to or less than the first predetermined time.

In the aspect of the disclosure, the interior light control unit may be configured to turn off the interior light when the remaining time to the switching time is equal to or less than a second predetermined time. The second predetermined time may be shorter than the first predetermined time.

In the aspect of the disclosure, the automatic driving system may further includes a dimming pattern generating unit configured to generate a dimming pattern of the interior light. The interior light control unit may be configured to perform the dimming control based on the dimming pattern.

In the aspect of the disclosure, the dimming pattern may include decreasing the illuminance of the interior light by a predetermined proportion.

In the aspect of the disclosure, the dimming pattern may include decreasing the illuminance of the interior light until a predetermined illuminance after the driving control unit switches the driving of the vehicle from the automatic driving to the manual driving.

In the aspect of the disclosure, the dimming pattern may include the illuminance of the interior light after the driving control unit switches the driving of the vehicle from the automatic driving to the manual driving.

According to the disclosure, it is possible to provide an automatic driving system that can reduce a likelihood that a driver will have difficulty in seeing the outside of a vehicle when driving of a vehicle is switched from automatic driving to manual driving.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram illustrating a configuration of an automatic driving system according to an embodiment;

FIG. 2 is a diagram illustrating an interior light of the automatic driving system illustrated in FIG. 1;

FIG. 3 is a flowchart illustrating a process flow which is performed by the automatic driving system illustrated in FIG. 1; and

FIG. 4 is a graph illustrating an example of a variation in illuminance of an interior light with respect to time.

### DETAILED DESCRIPTION OF EMBODIMENTS

Hereinafter, an embodiment of the disclosure will be described in detail with reference to the accompanying drawings. In the following description, the same or corresponding elements will be referenced by the same reference signs and description thereof will not be repeated.

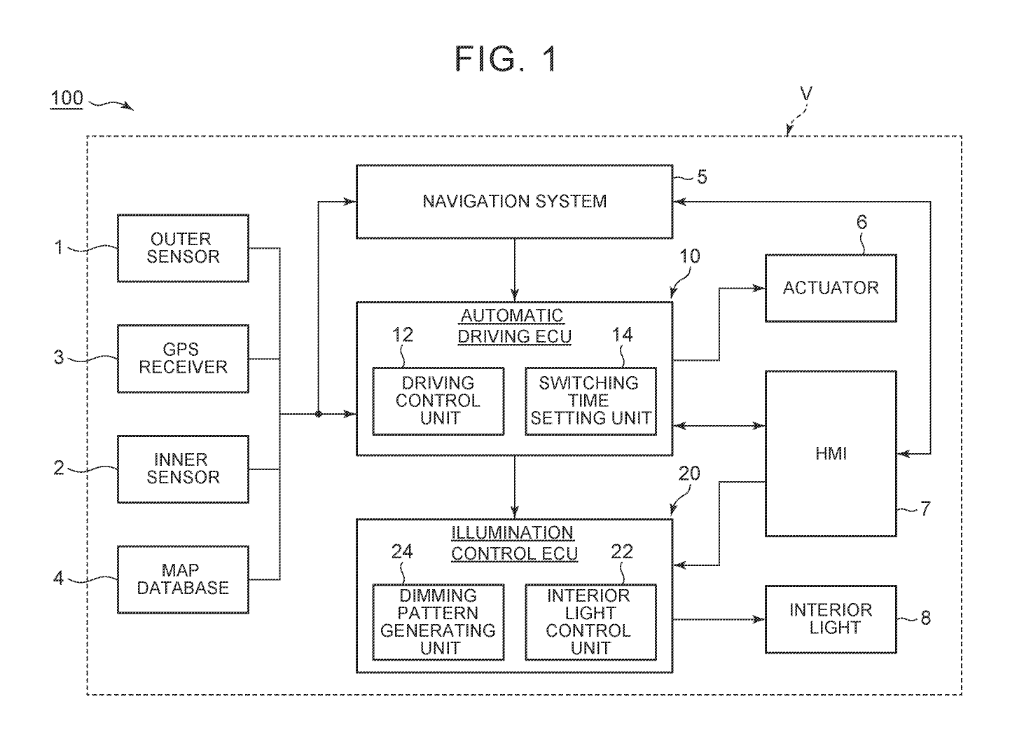

FIG. 1 is a block diagram illustrating a configuration of an automatic driving system 100 according to an embodiment. As illustrated in FIG. 1, the automatic driving system 100 is mounted in a vehicle V such as an automobile. The automatic driving system 100 includes an outer sensor 1, an inner sensor 2, a global positioning system (GPS) receiver 3, a map database 4, a navigation system 5, an actuator 6, a human machine interface (HMI) 7, an interior light 8, an automatic driving electronic control unit (ECU) 10, and an illumination control ECU 20.

The outer sensor 1 is a detector that detects surrounding conditions of a vehicle V. The outer sensor 1 includes at least one of a camera, a radar, and a laser imaging detection and ranging (LIDAR). The camera is an imaging device that images the surrounding conditions of the vehicle V. The camera may be a monocular camera or a stereoscopic camera. The stereoscopic camera includes two imaging units which are disposed to reproduce binocular parallax. The radar detects the surrounding conditions of the vehicle V using radio waves (for example, radio waves of 1 to 10 millimeters). The LIDAR detects the surrounding conditions of the vehicle V using light.

All of the camera, the LIDAR, and the radar do not have to be provided. The outer sensor 1 transmits information on the detected surrounding conditions to the automatic driving ECU 10. The surrounding conditions include at least one of situations of other vehicles around the vehicle V (for example, positions and speeds of other vehicles), a shape of a road (for example, curvatures of a traveling lane and a neighboring lane), and situations of obstacles around the vehicle (for example, positions of obstacles and moving directions and speeds of moving obstacles).

The inner sensor 2 is a detector that detects a traveling state of the vehicle V. The inner sensor 2 includes at least one of a vehicle speed sensor, an acceleration sensor, and a yaw rate sensor. The vehicle speed sensor is a detector that detects a speed of the vehicle V. A wheel speed sensor that detects a rotation speed of vehicle wheels is used as the vehicle speed sensor. The acceleration sensor is a detector that detects an acceleration of the vehicle V. The acceleration sensor includes a front-rear acceleration sensor that detects an acceleration in a front-rear direction of the vehicle V and a lateral acceleration sensor that detects a lateral acceleration of the vehicle V. The yaw rate sensor is a detector that detects a yaw rate (a rotational angular velocity) about a vertical axis through the center of gravity of the vehicle V. A gyro sensor can be used as the yaw rate sensor.

The inner sensor 2 includes at least one of a steering sensor, an accelerator sensor, a brake sensor, and a turn signal sensor. The steering sensor detects a steering operation by a driver or the automatic driving system 100. The accelerator sensor detects an accelerator operation by the driver or the automatic driving system 100. The brake sensor detects a braking operation by the driver or the automatic driving system 100. The turn signal sensor detects a turn indicator (direction indicator light) operation by the driver or the automatic driving system 100.

The steering sensor, the accelerator sensor, the brake sensor, and the winker sensor are not particularly limited, and various known sensors can be used. All of the steering sensor, the accelerator sensor, the brake sensor, and the winker sensor do not have to be provided. The inner sensor 2 transmits information on the detected traveling state of the vehicle V to the automatic driving ECU 10. The traveling state includes at least one of a speed, an acceleration, a yaw rate, a steering angle, an accelerator operation amount, and a moving direction of the vehicle V.

The GPS receiver 3 measures a position of the vehicle V (latitude and longitude of the vehicle V) by receiving signals from three or more GPS satellites. The GPS receiver 3 transmits position information on the measured position of the vehicle V to the automatic driving ECU 10 and the navigation system 5. Another means that can specify the latitude and longitude of the vehicle V may be used instead of the GPS receiver 3.

The map database 4 is a database including map information. The map database is stored in a hard disk drive (HDD) which is mounted in the vehicle V. The map information includes position information of roads, information of shapes of roads (for example, types of curved parts and linear parts and curvatures of curved parts), and position information of intersections and junctions. The map database 4 may be stored in a computer in a facility such as an information processing center that can communicate with the vehicle V.

The navigation system 5 is a system that guides a driver of the vehicle V to a destination which is set by the driver of the vehicle V. The navigation system 5 calculates a route on which the vehicle V travels based on the position information of the vehicle V measured by the GPS receiver 3 and the map information of the map database 4. The route may specify a suitable lane in a section including a plurality of lanes. The navigation system 5 calculates a target route from a current position of the vehicle V to an arrival destination. The navigation system 5 transmits information of the target route of the vehicle V to the automatic driving ECU 10. The navigation system 5 may be stored in a computer in a facility such as an information processing center that can communicate with the vehicle V.

The actuator 6 is a device that performs traveling control of the vehicle V. The actuator 6 includes at least an engine actuator, a brake actuator, and a steering actuator. The engine actuator controls an amount of air supplied (a throttle opening level) to an engine in accordance with a control signal of the automatic driving ECU 10 and controls a driving force of the vehicle V. When the vehicle V is a hybrid vehicle, in addition to the amount of air supplied to the engine, a control signal from the automatic driving ECU 10 is input to a motor serving as a power source and the driving is controlled. When the vehicle V is an electric vehicle, a control signal from the automatic driving ECU 10 is input to a motor serving as a power source and the driving force is controlled. The motors serving as a power source in these cases constitute the actuator 6.

The brake actuator controls a brake system in accordance with a control signal from the automatic driving ECU 10 and controls a braking force which is applied to wheels of the vehicle V. A hydraulic brake system can be used as the brake system. The steering actuator controls driving of an assist motor that controls a steering torque in an electric power steering system in accordance with a control signal from the automatic driving ECU 10. Accordingly, the steering actuator controls a steering torque of the vehicle V.

The HMI 7 is an interface that outputs and inputs information between an occupant (which includes a driver) of the vehicle V and the automatic driving system 100. The HMI 7 includes a display panel that displays image information, a speaker that outputs sound, and an operation button or a touch panel on which an input operation is performed by an occupant. Operation inputs of various functions are performed on the HMI 7 by an occupant. The operation inputs on the HMI 7 include an operation input for switching driving of the vehicle V between automatic driving and manual driving, an operation input associated with turning ON and OFF illumination control of an interior light 8 to be described later, and an operation input for setting a destination in the navigation system 5. The HMI 7 may output information for an occupant using a personal digital assistant (PDA) which is wirelessly connected thereto or may receive an operation input from an occupant using the PDA.

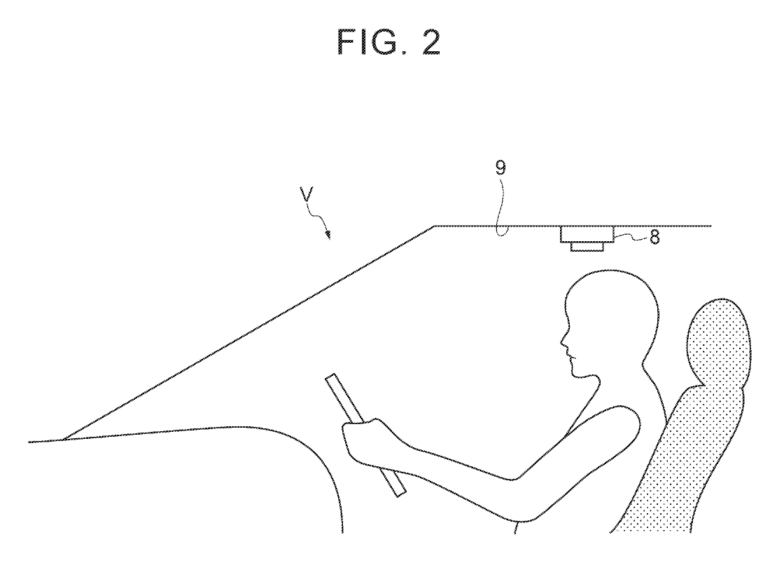

As illustrated in FIG. 2, the interior light 8 is a vehicle illumination device that illuminates a vehicle compartment 9 of the vehicle V. The interior light 8 includes a ceiling lamp which is disposed on the ceiling of the vehicle compartment 9. The interior light 8 includes a front-seat interior light which is disposed around an inside mirror. The interior light 8 includes a rear-seat interior light which is disposed on the ceiling above a rear-seat door. The interior light 8 includes a foot light which is disposed under a seat. The interior light 8 is not particularly limited and various illumination devices can be used. A single interior light 8 may be disposed in the vehicle compartment 9 or a plurality of interior lights may be disposed.

For example, an LED may be used as the interior light 8. The interior light 8 is configured such that an illuminance thereof can be adjusted. For example, the interior light 8 may have a dimming function and an illuminance thereof may be adjusted in a stepped or stepless manner. When a single interior light 8 includes a plurality of LEDs, the illuminance may be adjusted by changing the number of LEDs turned on. The illuminance of the interior light 8 may be adjusted by adjusting a degree of light-shielding. The interior light 8 can be turned on and off by an operation input on a switch disposed around the interior light, an operation input on the HMI 7, or a voice input, or the like.

Referring to FIG. 1 again, the automatic driving ECU 10 and the illumination control ECU 20 are electronic control units each including a central processing unit (CPU), a read only memory (ROM), and a random access memory (RAM). The automatic driving ECU 10 and the illumination control ECU 20 perform a variety of controls by loading a program stored in the ROM into the RAM and causing the CPU to execute the read program. The automatic driving ECU 10 and the illumination control ECU 20 each may include a plurality of electronic control units.

The automatic driving ECU 10 includes a driving control unit 12 and a switching time setting unit 14. The driving control unit 12 performs automatic driving control of automatically driving the vehicle V based on at least one of surrounding conditions, a traveling state, and a position of the vehicle V, map data, and a target route. For example, the driving control unit 12 performs automatic driving control as follows.

The driving control unit 12 generates a course of the vehicle V based on the target route and the position and the surrounding conditions of the vehicle V. The course is a locus on which the vehicle V travels on the target route. The course is generated on the target route such that the vehicle V travels suitably in view of criteria such as safety, rule observance, and traveling efficiency. The target route includes a traveling route which is automatically generated based on the surrounding conditions or the map information when setting of a destination is not explicitly performed by a driver.

The driving control unit 12 generates a traveling plan corresponding to a preset target route based on at least the surrounding conditions and the map information. The driving control unit 12 may output the generated traveling plan such that the course of the vehicle V includes a plurality of sets including two elements of a target position p in a coordinate system fixed with respect to the vehicle V and a speed v at each target point, that is, a plurality of configuration coordinates (p, v). Each target position p includes at least a position of an x coordinate and a y coordinate in the coordinate system fixed with respect to the vehicle v or information equivalent thereto. The traveling plan is not particularly limited as long as it can describe a behavior of the vehicle V. The traveling plan may use a target time t instead of the speed v or may use a target time t and a direction of the vehicle V at that time added thereto.

The traveling plan includes a motion profile such as a position, a speed, and an acceleration of the vehicle V which serve as a target of the traveling control until a short time elapses from a current time. The motion profile is calculated in a range of motion limited in consideration of a ride quality while securing a margin with respect to walls or surrounding vehicles. The traveling plan may satisfactorily include data into the future of several seconds from the current time, but since several tens of seconds of data may be necessary depending on conditions such as turning right at an intersection or overtaking of the vehicle V, the number of sets of configuration coordinates in the traveling plan and distances between the sets of configuration coordinates may be varied. A curve connecting the sets of configuration coordinates may be approximated by a spline function or the like and parameters of the curve may be used as the traveling plan. An arbitrary known method can be used to generate the traveling plan, as long as it can describe the behavior of the vehicle V. The traveling plan may be constituted by data indicating changes of a vehicle speed, an acceleration/deceleration, and a steering torque of the vehicle V and the like when the vehicle V travels on the course corresponding to the target route. The traveling plan may include a speed pattern, an acceleration/deceleration pattern, and a steering pattern of the vehicle V.

The speed pattern is data including a target vehicle speed set in association with the time for each target control position, the target control positions being set at predetermined intervals on the course. The acceleration/deceleration pattern is data including a target acceleration/deceleration set in association with the time for each target control position, the target control positions being set at predetermined intervals on the course. The steering pattern is data including a target steering torque set in association with the time for each target control position, the target control positions being set at predetermined intervals on the course.

The driving control unit 12 automatically controls traveling of the vehicle V based on the generated traveling plan. The driving control unit 12 outputs a control signal corresponding to the traveling plan to the actuator 6. Accordingly, the driving control unit 12 performs automatic driving control of automatically driving the vehicle V in accordance with the traveling plan.

Automatic driving control of the driving control unit 12 is not limited to the above-mentioned example. When the vehicle V includes an on-board communication unit that performs road-to-vehicle communication or vehicle-to-vehicle communication, the driving control unit 12 may perform automatic driving control of automatically driving the vehicle V by remote control via the on-board communication unit. The driving control unit 12 may perform traveling control of automatically driving the vehicle V such that it follows a preceding vehicle based on information on the preceding vehicle acquired via the on-board communication unit. In such automatic driving control, at least one of the surrounding condition, the traveling state, the position, the map data, and the target route of the vehicle V may be used.

The driving control unit 12 can end the automatic driving control which is being performed and switch the driving of the vehicle V from automatic driving to manual driving. A switching time is input from the switching time setting unit 14 to the driving control unit 12. When a current time reaches the switching time, the driving control unit 12 ends the automatic driving control which is being performed and switches driving of the vehicle V from automatic driving to manual driving. When the switching time is input, the driving control unit 12 outputs a message indicating that the driving has switched from automatic driving to manual driving from the HMI 7.

The switching time setting unit 14 sets the switching time which is a time at which the driving control unit 12 switches the driving of the vehicle V from automatic driving to manual driving during the automatic driving control. The switching time setting unit 14 outputs the set switching time to the driving control unit 12 and the illumination control ECU 20. For example, the switching time setting unit 14 sets the switching time as follows.

The switching time setting unit 14 predicts and sets a time at which the vehicle V will enter an area in which automatic driving is not permitted as the switching time based on at least one of the surrounding condition, the traveling state, the position, and the map data of the vehicle V while the vehicle V is being automatically driven by automatic driving control. In this case, prediction of the switching time may be performed based on the traveling plan generated by the driving control unit 12.

When a target route can be acquired by the navigation system 5 or on-board communication information of the on-board communication unit while the vehicle V is being automatically driven by automatic driving control on a specific road (such as an expressway) in which automatic driving is permitted, the switching time setting unit 14 determines whether the vehicle V is going to exit to a general road in which automatic driving is not permitted based on the target route. When it is determined that the vehicle V is going to exit to a general road, the switching time setting unit 14 predicts and sets the time at which the vehicle will exit as the switching time. In this case, prediction of the switching time may be performed based on at least one of the surrounding conditions, the traveling state, the position, and the map data of the vehicle V or may be performed based on the traveling plan generated by the driving control unit 12.

When a target route cannot be acquired while the vehicle V is being automatically driven by automatic driving control on a specific road in which automatic driving is permitted, the vehicle V changes a lane in the vicinity of an exit gate of the specific road, and the vehicle V is decelerated, the switching time setting unit 14 predicts and sets the time at which the vehicle will exit from an exit gate as the switching time. In this case, prediction of the switching time may be performed based on at least one of the surrounding condition, the traveling state, the position, and the map data of the vehicle V or may be performed based on the traveling plan generated by the driving control unit 12.

When an operation input of switching the driving of the vehicle V from automatic driving to manual driving (an ON operation of a cancel switch of automatic driving) is performed on the HMI 7 while the vehicle V is being automatically driven by automatic driving control, the switching time setting unit 14 sets a time a preset waiting time after a time point of the operation input as the switching time. The preset waiting time is a time which is set and stored in the automatic driving ECU 10 in advance. The preset waiting time may be a fixed value or a variable value which varies depending on, for example, the traveling state of the vehicle V.

When it is predicted that a preceding vehicle is separated away (the preceding vehicle is lost) until automatic driving becomes impossible while the vehicle is being automatic driven by automatic driving control of causing the vehicle V to travel such that the vehicle V follows the preceding vehicle, the switching time setting unit 14 sets a time immediately before a time at which the automatic driving becomes impossible as the switching time. The time at which the automatic driving becomes impossible can be predicted based on at least one of the surrounding condition, the traveling state, the position, and the map data of the vehicle V and the on-board communication information of the on-board communication unit.

When it is predicted that the vehicle V enters an area in which remote control is impossible while the vehicle V is being automatically driven by remote control via the on-board communication unit, the switching time setting unit 14 sets a time immediately before the vehicle V enters the area in which remote control is impossible as the switching time. The time at which the vehicle T enters the area in which remote control is impossible can be predicted based on at least one of the surrounding condition, the traveling state, the position, and the map data of the vehicle V and the on-board communication information of the on-board communication unit. When abnormality of the automatic driving system 100 is detected, the switching time setting unit 14 sets a time immediately after abnormality is detected as the switching time.

The illumination control ECU 20 includes an interior light control unit 22 and a dimming pattern generating unit 24. The interior light control unit 22 controls the interior light 8. When the interior light 8 is in an ON state while the automatic driving control is being performed, the interior light control unit 22 performs dimming control before the driving control unit 12 switches the driving of the vehicle V from automatic driving to manual driving. Specifically, when the interior light 8 is in the ON state while the automatic driving control is being performed, the interior light control unit 22 performs the dimming control prior to the switching time set by the switching time setting unit 14. More specifically, when the interior light 8 is in the ON state while the automatic driving control is being performed and a remaining time to the switching time set by the switching time setting unit 14 is equal to or less than a predetermined time, the interior light control unit 22 performs the dimming control.

Whether to the automatic driving control is being performed may be determined, for example, depending on whether an automatic driving flag is set up or whether an automatic driving execution signal indicating that the automatic driving control is being performed is input from the automatic driving ECU 10. The automatic driving flag is set up while the driving control unit 12 is performing the automatic driving control. Whether the interior light 8 is in the ON state may be determined, for example, depending on whether an ON flag of the interior light 8 is set up or whether an ON state signal indicating an electric power supplied to the interior light 8 or an ON state of the interior light 8 is input from the interior light 8. The ON flag of the interior light 8 is set up when the interior light 8 is in the ON state.

The ON state is a state in which the interior light 8 is lighted and illuminates the vehicle compartment. The ON state is a state in which an illuminance of the interior light 8 is greater than 0. The switching time is input and acquired from the switching time setting unit 14. The remaining time to the switching time is a time between a current time and the switching time and is a remaining time to the switching time. The predetermined time is a time which is set and stored in the illumination control ECU 20 in advance. The predetermined time may be a fixed value or a variable value, for example, depending on the traveling state of the vehicle V.

The dimming control is control of decreasing an illuminance (brightness) of the interior light 8. The dimming control adjusts the interior light 8 such that the illuminance decreases based on the dimming pattern generated by the dimming pattern generating unit 24. The dimming control includes a control of decreasing the illuminance of the interior light 8 to 0, that is, control of turning off the interior light 8. A specific technique or method of controlling the interior light 8 using the interior light control unit 22 is not particularly limited, and various known techniques or methods may be used as long as they can decrease the illuminance of the interior light 8.

When the interior light 8 is in the ON state while the automatic driving control is being performed and the remaining time to the switching time set by the switching time setting unit 14 is equal to or less than a predetermined short time, the interior light control unit 22 turns off the interior light 8. The short time is a time which is set and stored in the illumination control ECU 20 in advance. The short time is shorter than the predetermined time. The short time may be a fixed value or a variable value, for example, depending on the traveling state of the vehicle V. The interior light control unit 22 turns off the interior light 8 when the remaining time to the switching time is equal to or less than the short time, but may change the interior light 8 to a state in which the illuminance is left darksome.

The dimming pattern generating unit 24 generates a dimming pattern which is used for the dimming control by the interior light control unit 22. The dimming pattern is a pattern associated with a decrease in illuminance when the illuminance of the interior light 8 is decreased. The dimming pattern is a method of dimming the interior light 8. The dimming pattern may be a pattern in which the illuminance is decreased by a predetermined constant proportion or a variable proportion with the lapse of time. The dimming pattern may be a pattern in which the illuminance is decreased in a stepped manner with the lapse of time. The dimming pattern may be a pattern in which the illuminance is slowly decreased and then rapidly decreased or a reversed pattern thereof. The dimming pattern may be a pattern in which the illuminance is finally decreased to 0 (the light is turned off).

The dimming pattern may be a pattern which is responsive to an operation input (a taste) from a driver. The operation input of the dimming pattern can be input via the HMI 7. The dimming pattern may be a pattern corresponding to a driver. In this case, for example, a dimming pattern in which the illuminance is decreased at a sluggish rate may be used when a driver is an old person, and a dimming pattern in which the illuminance is decreased at a sharp rate may be used when a driver is a young person. The driver information can be acquired by an operation input on the HMI 7 or an interior camera. The dimming pattern may be a pattern corresponding to surrounding conditions. The dimming pattern may be a pattern in which the illuminance is decreased at a sharp rate when the surrounding conditions of the vehicle V are an urban area which is bright at night. The “sluggish rate” and the “sharp rate” mean that they are lower and higher than an arbitrary reference rate. The surrounding conditions may be surrounding conditions of a road on which the vehicle V is currently traveling.

The dimming pattern may be determined by predicting the surrounding conditions of a road on which the vehicle V travels after the switching time at which the driving of the vehicle is switched from automatic driving to manual driving in advance. For example, when the surrounding conditions of a road on which the vehicle V travels after the switching time are an urban area which is bright at night, the dimming pattern may be a pattern in which the interior light 8 is finally changed to a state in which the illuminance is left darksome. When the surrounding conditions of a road on which the vehicle V travels after the switching time are predicted to be darker than the urban area or the like, with no street light in the surroundings, the dimming pattern may be a pattern in which the illuminance is finally decreased to 0 (the light is turned oft). In this way, by adjusting the dimming pattern depending on the surrounding conditions of a road on which the vehicle V travels by manual driving, it is possible to further reduce a likelihood that a driver has difficulty in seeing the outside of a vehicle. The surrounding conditions of a road on which the vehicle V travels by manual driving may be acquired by the outer sensor 1 or may be determined based on the map database 4 or the navigation system 5.

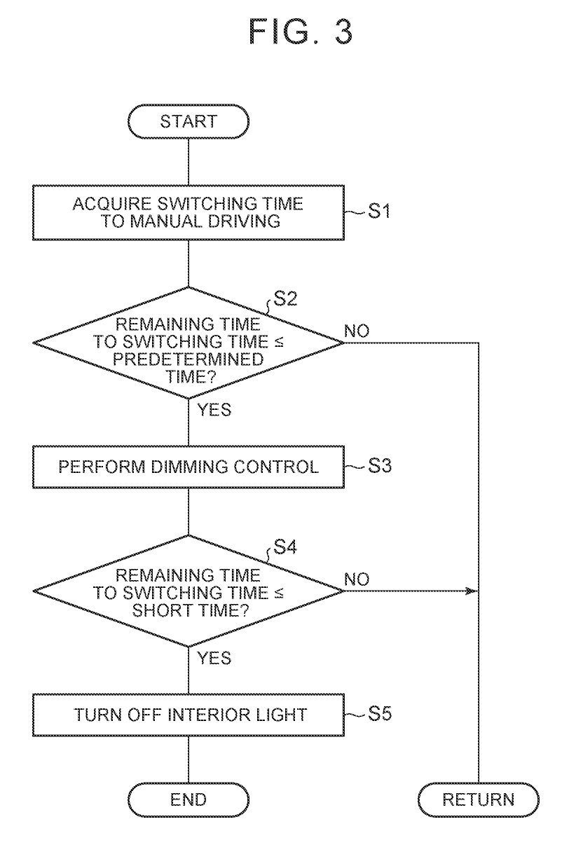

An example of a process flow for illumination control of the interior light 8 which is performed by the automatic driving system 100 when the vehicle V is driven by automatic driving will be specifically described below with reference to the flowchart illustrated in FIG. 3.

In the automatic driving system 100, the illumination control ECU 20 performs the following process flow, when the interior light 8 is in the ON state while the driving control unit 12 is performing the automatic driving control and an operation input for performing illumination control is input to the HMI 7 by a driver (activation of the illumination control is requested).

The interior light control unit 22 acquires a switching time from automatic driving to manual driving from the switching time setting unit 14 (Step S1). The interior light control unit 22 determines whether a remaining time to the switching time is equal to or less than a predetermined time (Step S2). When the determination result of Step S2 is YES, the interior light control unit 22 performs dimming control based on a dimming pattern generated by the dimming pattern generating unit 24 (Step S3). A message indicating that driving is switched from automatic driving to manual driving and a message indicating that the dimming control is performed may be output from the HMI 7 at the same time as performing the process of Step S3.

The interior light control unit 22 determines whether the remaining time to the switching time is equal to or less than a short time (Step S4). When the determination result of Step S4 is YES, the interior light control unit 22 turns off the interior light 8 and ends the process flow. When the determination result of Step S2 is NO or the determination result of Step S4 is NO, the process flow returns to Step S1. When the interior light 8 is turned off by an occupant or when an operation input of turning off the dimming control is input to the HMI 7 by an occupant, the process flow ends.

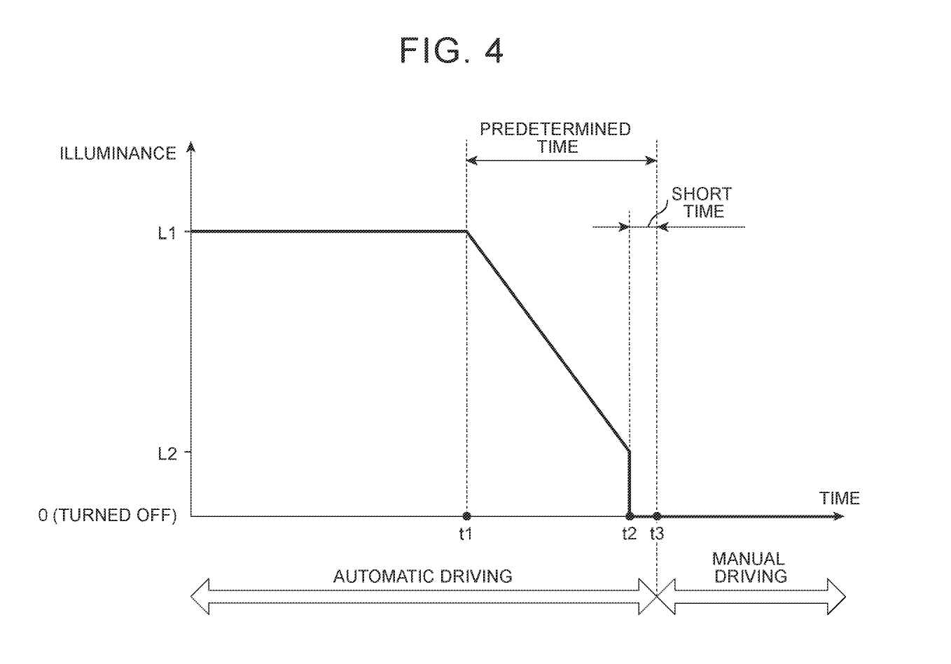

FIG. 4 is a graph illustrating an example of a variation in illuminance of the interior light 8 with respect to time. While the vehicle V is being driven by automatic driving in the night, a driver may turn on the interior light 8 to make the vehicle compartment 9 bright and may take part in activities in the vehicle compartment 9 (for example, a driver may turn on the interior light 8 to read a book while driving the vehicle by automatic driving on an expressway). In this case, as illustrated in FIG. 4, the vehicle V is driven by automatic driving and the interior light 8 is in the ON state at a constant illuminance L1.

When a switching time t3 is set by the switching time setting unit 14, dimming control using a dimming pattern in which the illuminance is decreased by a predetermined proportion is performed from time t1 which is a predetermined time prior to the switching time t3 and the illuminance of the interior light 8 is linearly decreased with the lapse of time in the example illustrated in FIG. 4. The interior light 8 is turned off at time t2 which is prior to the switching time t3 by a short time. Thereafter, at the switching time t3, driving of the vehicle V transitions from automatic driving to manual driving.

As described above, in the automatic driving system 100, when the interior light 8 is in the ON state while the vehicle V is being driven by automatic driving, the illuminance of the interior light 8 can be decreased before the driving of the vehicle V is switched from automatic driving to manual driving, thereby allowing a driver's eyes to easily adapt to the darkness outside the vehicle. Pupils which have been narrowed because a driver is accustomed to a bright vehicle compartment 9 can be easily enlarged before the driving is switched from automatic driving to manual driving, and it is thus possible to enhance visibility for the darkness outside the vehicle. Accordingly, when the driving of the vehicle V is switched from automatic driving to manual driving, it is possible to reduce a likelihood that a driver has difficulty in seeing the outside of the vehicle.

In the automatic driving system 100, when the interior light 8 is in the ON state while the vehicle V is being driven by automatic driving, the illuminance of the interior light 8 can be decreased from a predetermined time prior to the set switching time, thereby allowing a driver's eyes to easily adapt to the darkness outside the vehicle.

While an embodiment of the disclosure has been described above, the disclosure is not limited to the embodiment and can be modified in various forms.

In the above-mentioned embodiment, a part of the functions of the automatic driving ECU 10 and the illumination control ECU 20 may be performed by a computer in a facility such as an information processing center that can communicate with the vehicle V. In the above-mentioned embodiment, the process flow illustrated in FIG. 3 which is performed by the illumination control ECU 20 may be performed when it is determined that the surrounding of the vehicle V is dark, such as when it is at night or it is rainy, based on the surrounding conditions from the outer sensor 1.

In the above-mentioned embodiment, when abnormality of the automatic driving system 100 is detected or when an operation input for switching driving of the vehicle V from automatic driving to manual driving is performed, the interior light control unit 22 may immediately turn off the interior light 8 and the driving control unit 12 may immediately switch the driving to manual driving.

In the above-mentioned embodiment, the controls which are performed by the automatic driving ECU 10 and the illumination control ECU 20 may be performed by one ECU.

In the above-mentioned embodiment, the automatic driving system may include a switching point setting unit that sets a switching point at which driving of the vehicle V is switched from automatic driving to manual driving while the automatic driving control is being performed. In this case, the interior light control unit 22 may perform the dimming control, when the interior light 8 is in the ON state while the automatic driving control is being performed and a remaining distance to the switching point set by the switching point setting unit is equal to or less than a predetermined distance.

What is claimed is:

1. An automatic driving system comprising:
an interior light configured to illuminate a vehicle compartment of a vehicle;
an interior light control unit configured to control the interior light; and
a driving control unit configured to perform automatic driving control of automatically driving the vehicle, end the automatic driving control when the automatic driving control is being performed, and switch driving of the vehicle from automatic driving to manual driving; wherein
the interior light control unit is configured to perform, when the interior light is lighted while the automatic driving control is being performed, dimming control of decreasing an illuminance of the interior light before the driving control unit switches the driving of the vehicle from the automatic driving to the manual driving.

2. The automatic driving system according to claim 1, further comprising
a switching time setting unit configured to set, while the automatic driving control is being performed, a switching time at which the driving control unit switches the driving of the vehicle from the automatic driving to the manual driving, wherein
the interior light control unit is configured to perform the dimming control, when both of a first condition and a second condition are satisfied, the first condition being a condition that the interior light is lighted while the automatic driving control is being performed, and the second condition being a condition that a remaining time to the switching time is equal to or less than a first predetermined time.

3. The automatic driving system according to claim 2, wherein
the switching time setting unit is configured to predict a timing, based on at least one of a surroundings condition of the vehicle, a traveling state of the vehicle, a position of the vehicle, and map data of the vehicle, the timing being a time at which the vehicle enters a first area in which traveling by the automatic driving is not permitted or a second area in which traveling by the automatic driving is not possible, and the switching time setting unit is configured to set the timing as the switching time.

4. The automatic driving system according to claim 2, wherein
the interior light control unit is configured to decrease the illuminance of the interior light by a predetermined proportion at predetermined intervals, when the remaining time to the switching time is equal to or less than the first predetermined time.

5. The automatic driving system according to claim 4, wherein
the interior light control unit is configured to turn off the interior light when the remaining time to the switching time is equal to or less than a second predetermined time, the second predetermined time being shorter than the first predetermined time.

6. The automatic driving system according to claim 1, further comprising
a dimming pattern generating unit configured to generate a dimming pattern of the interior light, wherein
the interior light control unit is configured to perform the dimming control based on the dimming pattern.

7. The automatic driving system according to claim 6, wherein
the dimming pattern generating unit is configured to predict, while the automatic driving control is being performed, a surroundings condition of a road on which the vehicle travels after the driving control unit switches the driving of the vehicle from the automatic driving to the manual driving, and the dimming pattern generating unit is configured to generate the dimming pattern based on the surroundings condition of the road.

8. The automatic driving system according to claim 7, wherein
the dimming pattern includes decreasing the illuminance of the interior light by a predetermined proportion.

9. The automatic driving system according to claim 7, wherein
the dimming pattern includes decreasing the illuminance of the interior light until a predetermined illuminance after the driving control unit switches the driving of the vehicle from the automatic driving to the manual driving.
